(19) United States
(12) Patent Application Publication
(10) Pub. No.: US 2003/0090514 A1
(43) Pub. Date: May 15, 2003

(54) Business process user interface generation system and method

(76) Inventors: Douglas J. Cole, Valley Forge, PA (US); Paul Zielinski, Gilbertsville, PA (US); Steve Fuschino, Pottstown, PA (US); John D. Haley, Honey Brook, PA (US); William J. Connor, Wayne, PA (US)

Correspondence Address: Siemens Corporation, Intellectual Property Department, 186 Wood Avenue South, Iselin, NJ, 08830, US

(21) Appl. No.: 10/251,285

(22) Filed: Sep. 20, 2002

Related U.S. Application Data
(60) Provisional application No. 60/347,903, filed on Oct. 23, 2001.

(51) Int. Cl. G09G 5/00

(52) U.S. Cl. 345/744

(57) ABSTRACT

A system and a method are described for providing a rule-based dynamic computer user interface for healthcare workers that emulates workflow. The system and method facilitate customization of user interface by the healthcare institution. A software model is presented that provides at least one of: a) an area for development of code (i.e., Build), b) an area that represents industry best practice business rules and work flows (i.e., Default/Model), and c) an area where customer specific adaptations reside (i.e., Client/Enterprise). Business processes are provided within the software model that describes all possible processes that might be used by a health care organization. Capability is then provided to adapt the defined business processes by scenario and/or context and in real time, changing flow of user interface screens and information presented to each user. A user interface is provided that has a consistent look and feel across all functions.

### CROSS REFERENCE TO RELATED APPLICATION

This application claims the benefit of a provisional U.S. application, U.S. Serial No. 60/347,903, filed Oct. 23, 2001, in the names of Douglas Cole et al.

### FIELD OF THE INVENTION

This invention generally relates to a system and method for user interface generation. More particularly, the present invention provides a solution to building computer user interfaces for healthcare providers that incorporates and enforces the complex rules of the various healthcare stakeholders while facilitating customization by the healthcare institutions.

### BACKGROUND OF THE INVENTION

Prior systems have approached solving the problem of user interface (UI) generation by building, sometimes quite extensive, “User Interface Builders” (e.g., screen builders, GUI (Graphical User Interface) builders, form builders, etc.). The systems then enable healthcare institutions to build, sometimes from scratch, customized user interfaces that incorporate their institutional customizations and external stakeholder rules. Using these user interface builders, the healthcare organization's IS (information systems) staff build customized user interfaces for each user group and/or business context.

A primary disadvantage with prior systems is that the customizations and rules need to be incorporated individually into each different user interface. Whenever the same business rules or customization need to be incorporated into multiple user interfaces or views, which is extremely common, the prior systems typically require the changes to be coded into each unique user interface.

With these types of solutions, when the needs of the institution's or the stake holder's business rules change, extensive, “one-by-one” re-customization is needed. Large integrated healthcare networks therefore need significant IS staff to address these constantly changing requirements. Due to the rapidity of the changing requirements, the IS staff are usually not able to keep up with the needs of the institutions.

If the adaptations are not incorporated in a timely basis, then the lack of adherence to the stakeholders' rules may result in, for example, un-billable revenue, reductions in reimbursement, and/or increased receivables resulting from delays in payment from insurance and managed care organizations.

### SUMMARY OF THE INVENTION

The present inventors recognize the need to address the shortcomings of the prior systems as described above. The present invention provides a mechanism for reconciling the complex and overlapping rules for patient access and revenue cycle management in healthcare settings. While designed to address the requirements of the healthcare setting, the present invention is equally applicable to other industries where complex rules and processes are dictated by a variety of industry stakeholders.

In particular, the present inventors recognize that it is desirable for user interfaces for patient access and revenue cycle management users to be designed to meet, for example, the following criteria:

Be user-friendly and intuitive to minimize the education and training necessary for the users to accomplish their tasks.

Be customizable by the healthcare institution, without significant programming resources, to accommodate their unique requirements and to allow the healthcare institutions to rapidly adapt the user interface to address their constantly changing environment.

Enforce the business rules and processes that are established, not only by the healthcare institutions themselves, but also the other stakeholders in patient access and revenue cycle management. Examples of these other stakeholders include, but are not limited to: a) state, federal, and other governmental regulatory agencies b) insurance companies; c) state and federal health care programs such as Medicare, Medicaid, Champus; d) health professionals “best practice” guidelines; and e) managed care organizations billing, referral, and reimbursement rules.

Accordingly, one advantage of the present invention is to allow an application provider to pre-load and the healthcare customers to individually define the rules that are specified by each stakeholder as well as providing individual customizations needed by the healthcare institution. These rules are independently defined for each of the stakeholders. The invention then allows the healthcare institution to define the different contexts in which the rules should be enforced or checked. Using these contexts, the present invention uses a combination of static and dynamic UI generation to build the user interfaces for each context, incorporating the rules specified by the stakeholders of each process.

Thus, as the rules are modified, those that are dynamically generated into the user interface immediately come into effect, while those that require static generation are simply regenerated at the push of a button. These capabilities provide enormous benefit to the healthcare institution in rapidly incorporating the most recent updates or changes to these processing rules into the production system. That is, the present system provides rules definition and healthcare customization for each stakeholder. The present system also defines rules enforcement by a healthcare institution and enables dynamic rule execution.

This invention is not limited to be usable by healthcare providers or the healthcare field but may be applicable to other industries requiring complex rules and processes dictated by a variety of stakeholders. It is a system capable of dynamically generating a user interface based on business rules and processes that are established, not only by the relevant organizations (e.g., healthcare institutions) themselves, but also the other stakeholders in client access and revenue cycle management. It provides the ability for users to customize the interface without extensive programming experience. Also, since user interfaces adaptively incorporate rules specified by the stakeholders of each process, the most recent updates or changes to processing rules are presented to the user. This dynamic user interface maximizes workflow efficiency and enforces health system rules as defined by each entity.

Therefore, one exemplary embodiment according to the principles of the present invention is a method for building computer user interfaces for healthcare workers that emulates workflow, while facilitating customization by the healthcare institution without programming. The method establishes a context adaptability model identifying, for example, 3 layers: Build, Default/Model and Client/Enterprise. The method incorporates in these three layers: a) an area for development of code, b) an area that represents industry best practice business rules and flows, and c) an area where customer specific adaptations reside. Furthermore, the method defines business processes in the context adaptability model that describe all possible business processes that might be used by a health care organization. The method provides the capability to adapt the business processes using rule system elements that include one or more of the following types:

Constraints

Profile Properties

Process Transitions

Process States

Business Process Object Template

Actions

Allowable Value Lists

In another exemplary embodiment, a system for dynamically generating user interface display images supporting a particular business process is described. The system comprises a source of information identifying a sequence of tasks involved in a business process and associated template forms for user interface display. The system also comprises a tracking processor for identifying a particular task of the sequence of tasks and a template form associated with the particular task. In addition, an adaptation processor modifies data representing the identified form to adapt the identified form in response to user context information assisting identification of form requirements. The system further comprises an output processor for processing data representing the adapted form to be suitable for output communication.

### BRIEF DESCRIPTION OF THE DRAWINGS

In the drawing:

FIG. 1 illustrates a representative generic user interface according to the present invention.

FIG. 2 shows a specific example of the generic user interface shown in FIG. 1.

FIG. 3 illustrates one exemplary embodiment of the present invention.

FIG. 4 illustrates another exemplary embodiment of the present invention.

FIG. 5 shows an example of a Build area.

FIG. 6 shows an example of starter sets in Model System context level, as well as Client/Enterprise level.

FIG. 7 shows an example of a Rule System Element.

FIG. 8 shows an exemplary user interface screen according to the present invention.

FIG. 9 shows another exemplary user interface screen.

FIG. 10 illustrates examples of process transitions for a business process Checking for Person.

FIG. 11 shows an example of a state diagram according to the principles of the present invention.

FIG. 12 shows an exemplary system according to the principles of the present invention.

### DETAILED DESCRIPTION

The present invention allows an application provider to pre-load and its healthcare customers to individually define the rules that are specified by each stakeholder as well as the individual customizations needed by the healthcare institution. A rule as used herein comprises executable stored instruction that influences selection and sequencing of performance of tasks by personnel. A rule also as used herein may include a prescribed guide, a precept, or a model for how to present, conduct or regulate an action by using a form and data or the relations between form and data. A rule as used herein may also include a procedure for determining that healthcare claim elements comply with predetermined requirements including, health plan reimbursement conditions, health plan format requirements, a reimbursement formula, reimbursement constraints and a reimbursement computation procedure. The invention allows the healthcare institution to define the different contexts in which the rules should be enforced or checked. This model may be referred to as a business process context adaptability model. Based on the context model, the present invention uses a combination of static and dynamic UI generation to build the user interfaces for each context incorporating the rules specified by the stakeholders of each process.

As the rules are modified, those that are dynamically generated into the user interface immediately come into effect, while those that require static generation are simply regenerated at the push of a button. This capability provides enormous benefit to the healthcare institution by rapidly incorporating the most recent updates or changes to processing rules into the production system.

Customer adaptations may be preserved when the customer takes on new versions of the software. The customer adaptations are kept in physically separate files that are not affected by new model software deliveries.

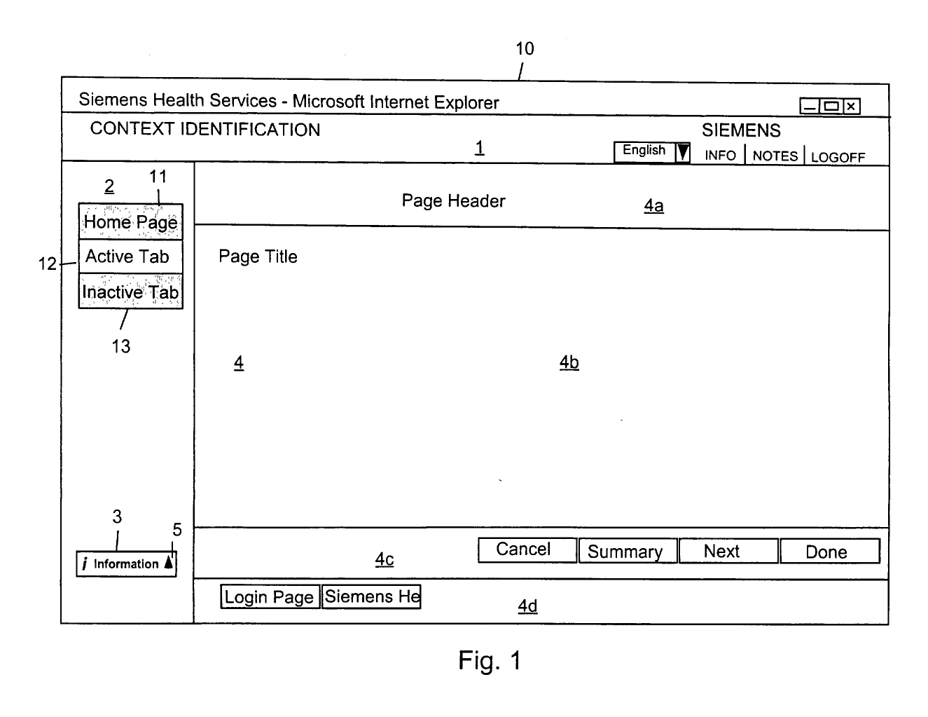

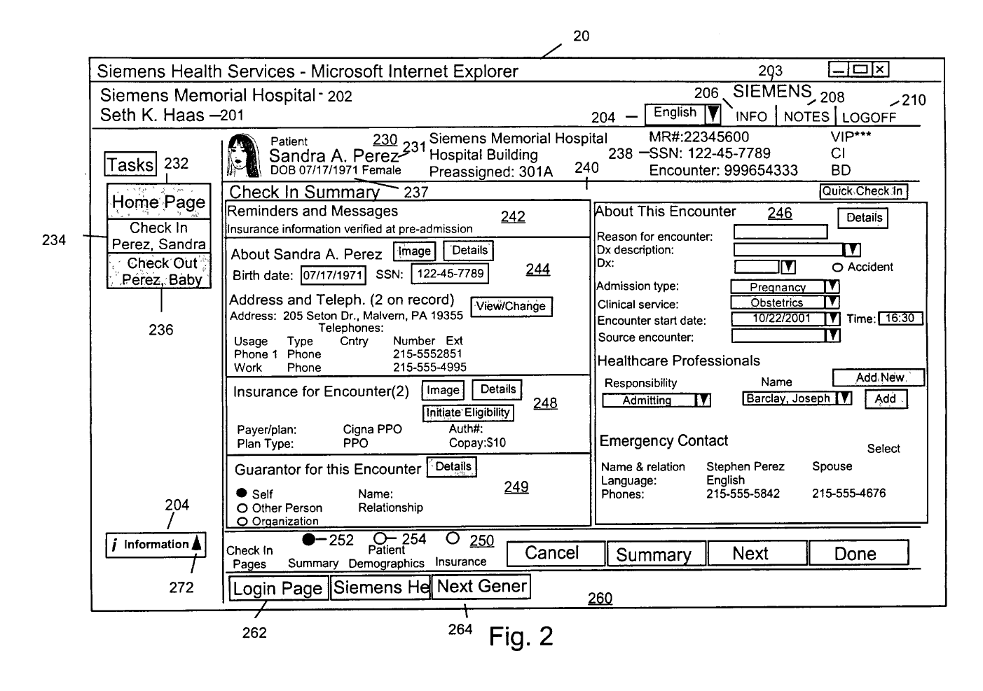

Although the information pushed to the user may vary by stakeholder or scenario, the look and feel of a user interface according to the principles of the present invention remains the same. The generic components of an exemplary user interface frame or window are shown in FIG. 1. The frame according to the present invention ensures consistency in presentation, even though the specific content may be different depending on each customer requirement or content. FIG. 2 shows one example of specific content of the generic user interface shown in FIG. 1.

As shown in FIG. 1, a generic representative user interface frame 10 comprises a Frame Header Area 1 that resides at the top area of the screen 10. This area 1 holds several common controls, making them available for viewing or selecting at all times. FIG. 2 shows some specific examples of common controls, including:

1) an identification icon 201, identifying which user is currently logged on, and any location context information which is part of the critical identification, shown as icon 202 “Siemens Memorial Hospital” of FIG. 2,

2) a logo icon 203, and

3) a button bar with common functions represented by various icons, such as a language selection icon 204, “Info” 206, “Notes” 208, and “Logoff” 210.

FIG. 1 also shows that the exemplary frame 10 comprises Task Navigation Area 2 at the left side of frame 10. Task Navigation Area 2 holds different Task Tabs 11 to 13, which allow the user to switch between different open tasks by selecting them, via for example, a user interface selection device such as a mouse.

Specific examples of Task Tabs are shown in UT frame 20 of FIG. 2. A first tab 232 is a permanent link to a home page, which may not be closed in the embodiment shown. The other tabs in Task Navigation Area represent any task started by the user, and may be from a mix of applications. Below the home tab 232, tabs are displayed in the order in which they are opened, with a visual differentiation between the active tab (white background) and inactive tab (shaded background). For example, an active tab 234 in FIG. 2 is a “Check In” application for patient Sandra Perez, followed by an inactive tab 236 representing “Check Out” application for Baby Perez.

Information Area 3 may also be incorporated in the exemplary frame 10, as shown in FIG. 1. An information area is, for example, located at the bottom of the left side of the frame. This small window 3 may be minimized, set to open halfway up the screen, or open completely (covering Task Tabs area 2), via arrow selection icon 5. Information Area 3 presents help information to the user that is context sensitive and changes as the user moves through the different applications. This area is also shown in FIG. 2 as element 204 of display screen 20.

In addition, exemplary frame 10 of FIG. 1 also comprises Work Area 4. Work Area 4 includes the entire well area of the frame 10 but may be further sub-divided into:

1) Well Page Header 4a—This area represents patient or other context information, as shown in FIG. 1. A specific example of this area is shown in area 230 of FIG. 2, which contains patient information such as for example, patent name 231, patient date of birth 237, and patient social security number 238, etc.

2) Well Page Area 4b—This area represents function pages related to the application being used by the user, as shown in FIG. 1. A specific example of this area is shown in area 240 of FIG. 2. In FIG. 2, this area 240 comprises application functions such as, for example, reminder message entry 242; patient information entry 244, encounter information entry 246, insurance information 248, and Guarantor information 249, etc.

3) Control Bar Area 4c—This is an area at the bottom of UI screen 10 for controlling workflow navigation, as shown in FIG. 1. A specific example of this area is shown in area 250 of FIG. 2. In FIG. 2, this area 250 comprises user selectable workflow navigation buttons such as Summary icon 252, Patient Demographics icon 254, etc.

4) Status Bar 4d—This is a message area at the bottom of the screen 10 of FIG. 1. A specific example of this area is shown in area 260 of FIG. 2. In FIG. 2, this area 260 comprises various selectable and applicable electronic status messages that are related to the system such as, for example, messages related to a login page 262, messages related to next generation system updates 264.

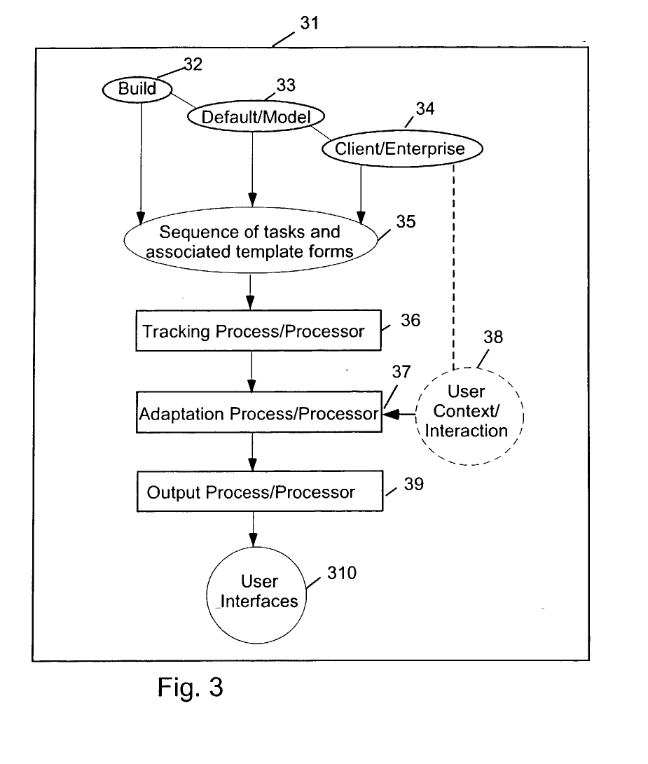

FIG. 3 illustrates in diagram form one exemplary embodiment of the present invention for dynamically generating user interface display images supporting a particular business process in accordance with the principles of the present invention. The system 31 comprises context layers: 1) Build 32, 2) Default/Model 33 and 3) Client/Enterprise 34 areas (to be described in more detail later). These context layers provide information identifying and controlling a sequence of tasks involved in a business process and associated template forms for user interface display, as shown in block 35 of FIG. 3.

The system further comprises a tracking processor or process 36 for identifying a particular task of the sequence of tasks and a template form associated with the particular task. The tracking processor/process 36 comprises a procedure for monitoring progress in the business process and for identifying a form associated with a current task to be performed in the business process.

The system also incorporates an adaptation processor or process 37 for modifying data representing the identified form to adapt the identified form in response to user context information 38 assisting identification of form requirements. The form adaptation processor 37 modifies the data representing the identified form to at least one of: (a) inactivate a display element in the identified form, (b) hide a display element in the identified form and (c) add a user selectable prompt display element in the identified form.

The user context information is derived, for example, from at least one of: (a) user logon identification information, (b) a user selection of an item in a displayed list of context identification items, and (c) a user prior navigation path through an executable application. Additionally, the user context information contains information identifying at least one of: (a) an organization associated with the user, (b) a department of an organization associated with the user, (c) an encounter type comprising a type of interaction of a patient with a healthcare enterprise, (d) a regulatory environment, (e) customer identification information, and (f) a computer system.

An output processor or process 39 is then used for processing data representing the adapted form to be suitable for output communication such as generating various adapted user interfaces 310, as shown in FIG. 3.

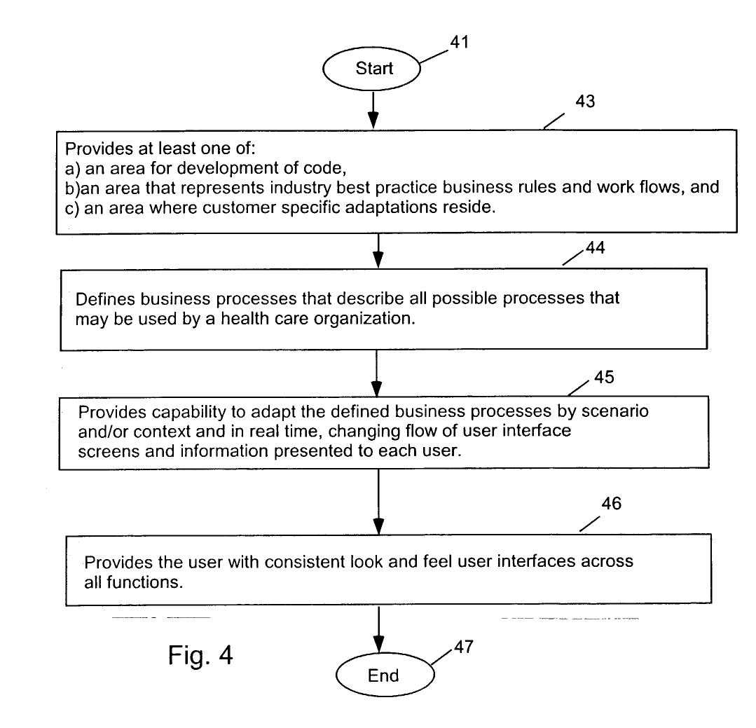

FIG. 4 illustrates another exemplary embodiment of the present invention. FIG. 4 shows in flow chart form, a method for building a rule-based dynamic computer user interface for healthcare workers that emulates workflow. The method facilitates customization by the healthcare institution. At step 43, the present invention establishes a software model that provides at least one of: a) an area for development of code (i.e., Build), b) an area that represents industry best practice business rules and workflows (i.e., Default/Model), and c) an area where customer specific adaptations reside (i.e., Client/Enterprise). At step 44, the present invention also defines business processes within the software model that describe all possible processes that might be used by a health care organization. At step 45, capability is then provided to adapt the defined business processes by scenario and/or context and in real time changing flow of user interface screens and information presented to each user. Furthermore, the user interface screens provided have a consistent look and feel across all functions, as at step 46.

Context Layers

In accordance with the principles of the present invention, a context adaptability framework drives the capabilities of the present user interface. A simplistic way to look at context layers according to the principles of the present invention is that a context layer represents grouping of business rules, parameters and business process adaptations. A business object or business process instance may operate within a specific context and inherit rules up the context hierarchy. For example, a registration process may be operating on behalf of a specific organization so the rules being applied would be those defined for that organization or context. At the same time, business objects interacting with that process may be operating within other contexts. For example, if the registration process uses a payer object instance, it may be operating within the context of “PA Blue Cross” which may have its own specific set of rules.

The physical hierarchy of the present system is logically divided into 3 context layers: 1) Build, 2) Default/Model and 3) Client/Enterprise.

Build area contains the basic items built and delivered to all customers by the software provider of the present invention. Default\Model area contains models that represent industry best practice business rules and flows for certain business processes like OP (Operation) Admissions, Dr. Office, and Emergency Room. Various analysts/experts may be used to develop these best practice models. Finally, Client/Enterprise area contains customer unique business processes and rules to support customization requirements.

Build

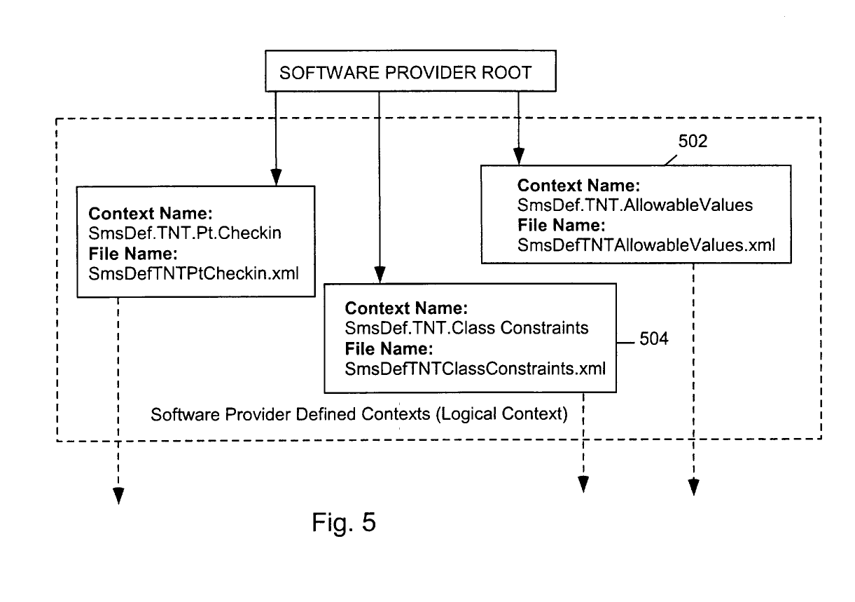

An example of a Build area is shown in FIG. 5. As shown in FIG. 5, defined context layers contain business process object templates describing all possible business processes that might be used by a health care organization. These include allowable value lists such as, for example, shown in block 502, and constraints relating to participant business objects, such as, for example, shown in block 504 of FIG. 5. These business process object templates are contained in associated files such as for example, SmsDefTNTAllowableValues.xml in block 502 and SmsDefTNTClassconstraints.xml in block 504 of FIG. 5. The definitions in this Build layer are never modified by the client, but only by the software provider.

Default/Model (System)

System context layer is below the software developer defined context layers (i.e., Build) and is where the model or default system components are defined. Initially, there may only be one model system context in this layer. Eventually there may be different model contexts for each country where the system is implemented or for varying kinds of healthcare facilities such as multi-entity, long-term care, etc., as the need arises. This framework provides the capability to inherit rules and parameters down the hierarchy. In this way, a health care service organization such as Health Provider Organization (HPO) may define rules that apply to all organizations belonging to it. It also allows model settings for rules to be applied in the user interface. At Default/Model (System) context level, different starter sets are provided so that a client may freely choose which to copy to the client context layer.

Although changes at the System context level are in effect for the entire system, a customer may determine which modifications may be blocked at different Client/Enterprise context layers below the system context layer. The system context layer sets the stage to support multiple models based on the best practices for a specific type of enterprise and ensures the ability to change the user interface display to suit the needs of the organization without programming changes.

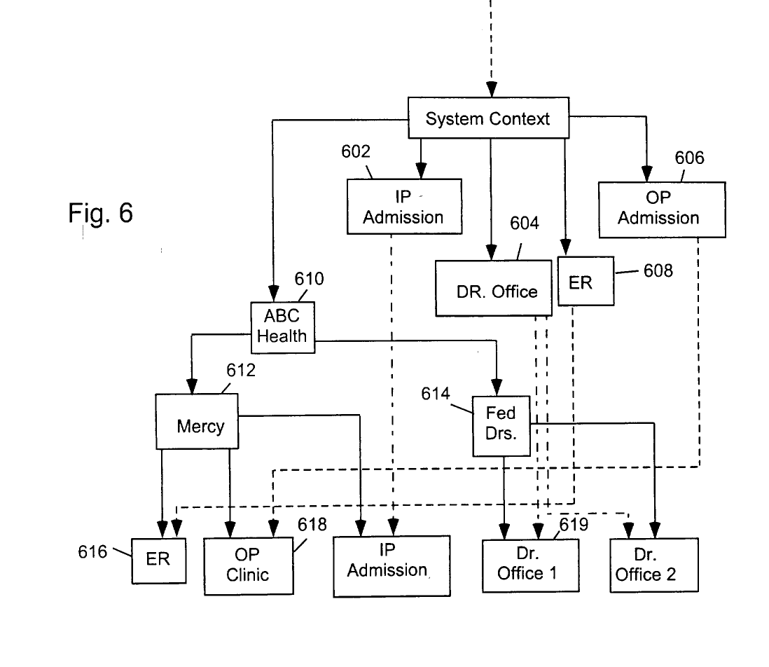

FIG. 6 shows an example of starter sets in the System context level. The starter sets or templates are depicted by shaded boxes in FIG. 6, such as for example, IP Admissions 602, Dr. Office 604, OP Admissions 606, and ER 608.

Client/Enterprise

The Client/Enterprise context layer is in the next/lower hierarchy, below the System context layer. The Client/Enterprise context layer (depicted by, for example, ABC Health 610 and other non-shaded boxes in FIG. 6) contains customer-specified adaptations of value lists, rules, constraints, etc. that are universally applicable to their entire health system. These may include different templates under ABC Health organization 610, such as, for example, Mercy clinic location 612, Federal Doctors location 614, as shown in FIG. 6.

Each of these locations may further contain other model or rules such as ER 616, OP Clinic 618, Dr. Office 1619, etc., shown in FIG. 6.

Rules/Rule System Elements

Once the context adaptability framework has been defined and the business processes established, Rule System Elements (RSEs) or rules are defined to drive the specific functions of a UI according to the present invention. These rules may drive the sequence of screens and the display of information. Rules are used to define validity checks and constraints, and to manage the transition from one business process to another. The flexibility with which rules may be changed to affect different outcomes accommodates the varying requirements of different health providers.

Context layers group together RSEs. Only those business rules, business processes, etc. that are present in the identified context layer are used to enable business process context adaptability. The system according to the present invention uses information in master files to determine the context in which a business process should be operating. Rules are used to define validity checks and constraints for business objects and business processes. For example, RSEs may be marked as blockable or not to facilitate the varying requirements of different health providers within the client context layer.

Rule System Elements may be categorized as, for example, the following types:

Constraints

Profile properties

Process transitions

Process states

Business process object templates

Actions

Allowable value lists

RSEs are “meta objects” interpreted by a rule system engine or processor to enforce business rules and processes. Every RSE may have the following common characteristics:

It has a start and stop date.

It is context aware and may be inherited down a context hierarchy.

It may be marked as not blockable below a specific context layer. This means that the rule may be defined in one context and enforced in all child (i.e., lower) contexts.

It may be overridden in child context as long as it is marked as blockable by its defining context and not marked as not blockable in any parent (i.e., higher) context.

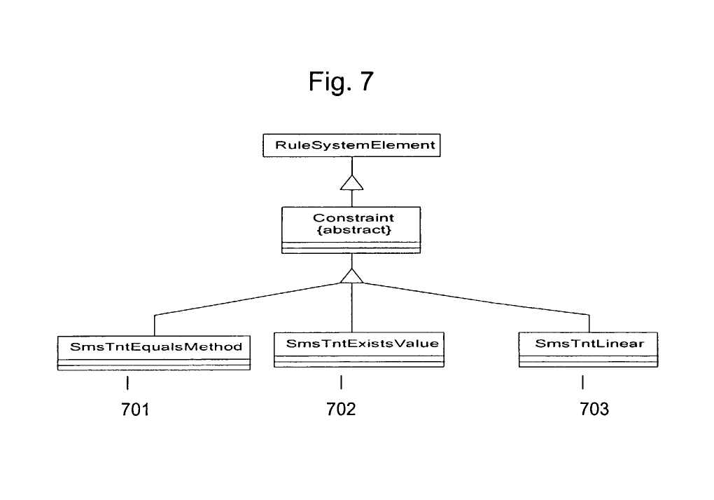

FIG. 7 shows pictorially an example of a rule or a rule system element. The particular example of RSE is a constraint.

Constraints

Constraints are used to enforce the rules that need to be satisfied in a given state of a business process. Each constraint represents one or more adaptable rules that understand the business process. Once the constraints are satisfied, the process is free to transition to some other state to accomplish more work. Constraints may be used to prevent an action from occurring or to transition to another state in the process.

Constraints may be used to guard an action or a transition to another state in the process. When used as a guard, the constraint again orchestrates the results of participating business object methods to determine if the business rules should allow the action or transition to occur. This allows business rules coded in the participating business objects to be leveraged when determining what actions or transitions need to occur.

Constraints are the primary expression of validation criteria. Constraints are applied (in conjunction with for example, another type of RSEs, actions, to be described below) to a business object to perform any of the following functions:

Check that a business object is valid.

Compute one or more business object properties based on the values of other properties.

Compute a candidate list for a property or set of properties.

Construct something intended for the UT component that would perform some or all of the constraint's validation logic at the user's browser.

Construct something intended for the UI component that would explain the reason why the business object is not now valid.

Constraints may also be associated with a process state to determine if the goals of the state are being met. When all the goals of a state are met, the process is said to be valid in its current state.

A constraint may also be associated with a process transition as a triggering event. These types of constraints are typically only executed when a process is valid in its current state. A process transition may be marked as immediate, which means it is evaluated before “valid in state” is checked. If the trigger event's constraints are satisfied, the process moves into the next state as defined by the process transition. There is one constraint associated with a trigger event.

Constraints may also be associated with a class. These are known as class constraints. Class constraints are evaluated each time a business object's validate method is invoked. Class constraints are context sensitive. When the business object's validate method is invoked and a context is not supplied, the context associated with the relevant organization or entity is used to gather the constraints for evaluation.

Class constraints may also be grouped. By grouping constraints within a context, a very specific group of constraints may be evaluated. This could be used to check the validity of an object to assure all the data are present and valid. Notifications are generated as a result of a special kind of class constraint. This class constraint is used to identify desired fields that a user would like to acquire but is not absolutely required. If desired data are not entered, a notification is generated indicating that the information was not collected. These notifications are then worked via a work list. Each notification type is associated with another business process which allows the user to enter the missed information. Selecting a notification from the work list launches a business process.

For example, a business process called “Create Face Sheet for Check In” may use constraints in the following ways. That is, any of following events may occur depending on the constraints defined:

1) Do not print a face sheet if one has already been generated for this encounter.

2) Generate a face sheet if a face sheet has not yet been created.

3) Do not print a face sheet if an error condition prevents this action from taking place.

Also, the exemplary constraint shown in FIG. 7 comprises three checking processes. The first is shown in block 701 “SmsTntEqualsMethod.” This block 701 represents a constraint to check whether two relevant parameters are equaled. Additionally, block 702 represents a checking process to see if a relevant parameter exists. Also, “SmsTntLiner” 703 shown in FIG. 7 represents a constraint that is complementary to block 701 in that constraint block 703 is true if, for example, two parameters are not equaled (e.g., >).

Profile Properties

A user interface according to the present invention may also change based on profile property settings. Each named profile property has exactly one value, which is a string of text. Profile properties are cached for performance and front ends are provided so that the user may easily manipulate them. The user interface may change based on the profile setting. For example, if the “collect money” profile is set to “true”, the user receives a prompt requesting that he or she collects payment from the patient upon check in. If the profile property is set to “false,” the prompt does not appear.

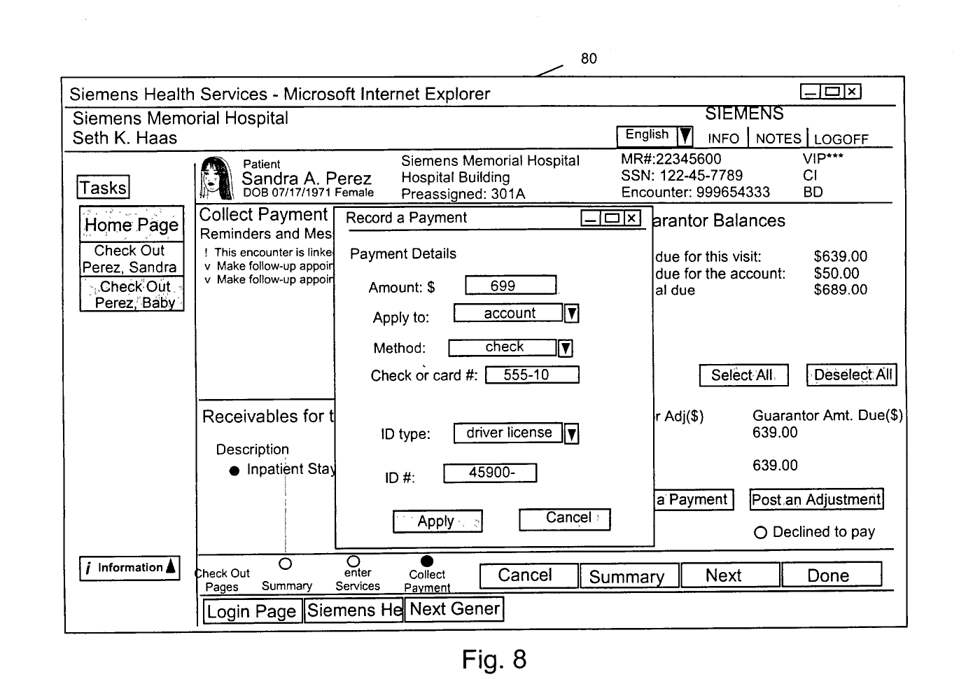

An example of using profile property to dynamically generating a UI screen is illustrated in FIG. 8. For example, a collect payment screen 80 appears if a “collect money” profile is set to “true” in a payment collection workflow of a particular user. A user of the system then receives a user interaction prompt such as window 80 requesting that he or she collects payment from the patient upon check out. If the “collect money” profile is set to “false,” the UI window 80 does not automatically appear. Thus, the UI is dynamically changed, in accordance with the present invention.

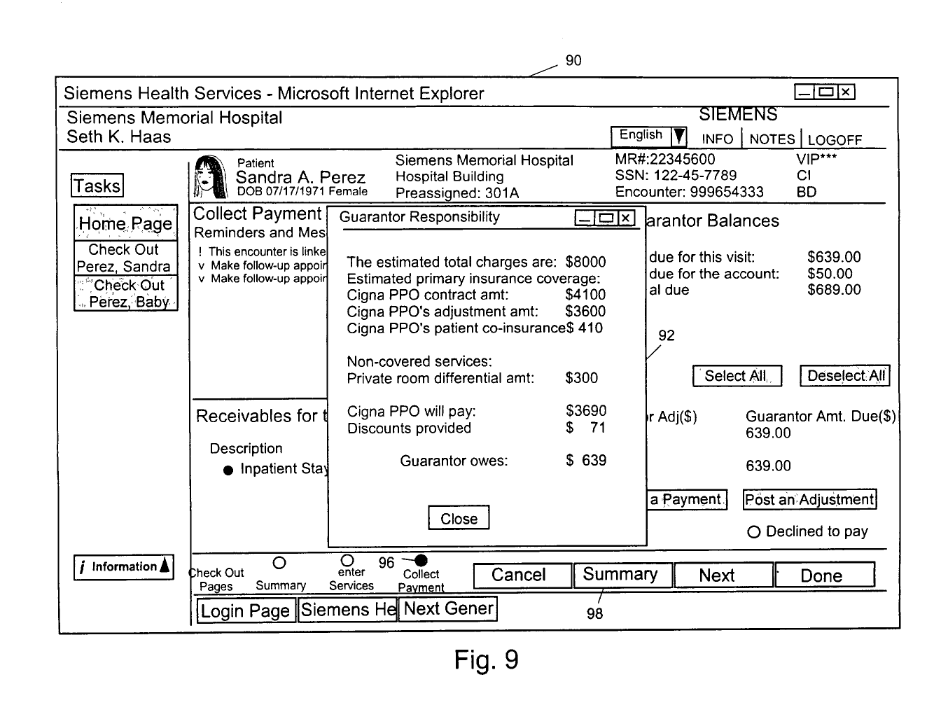

FIG. 9 shows another aspect of the present invention. User interface window 90 in FIG. 9 illustrates that the profile property may be overridden via a manual selection by the user. For, example, if the patient wishes to pay the guarantor sum due upon check out, even though the collect payment profile has not been set to automatically request payment as described in connection with FIG. 8 above, the user of the system may still manually invoke the “collect payment” screen 90 by a click of “collection payment” button 96 in the Control Bar area of screen 90. Furthermore, as shown in FIG. 9, the user may invoke a guarantor summary window 92, via a summary selection icon 98 so the patient may be told what he or she owes.

Process States

Process states roughly correspond to a step or a phase of a process. A business process may be in a given process state. Each process state may have its own set of constraints. The constraints for a process state need not be attached to a context layer since the state itself is defined for a specific context. There are zero or more constraints associated with a process state which signify the conditions that need to be true for a business process or object to be valid in the given state. These constraints may be looked at as the goals for a given process state. A process needs to be valid in its current state before any non-immediate transitions are evaluated.

When a business process is defined, the developer creates a set of all possible steps or conditions that are possible for a given business function. The system maintains a description of how the business process should flow. A business process may be used as a state within another business process. For example, a revised encounter business process may be incorporated in a business office business process such as collections.

Business Process Transitions

A business process transits from one process state to another. A process transition instance connects two states—the “from” and “to” states—within the same business process. A process transition instructs the system when to transition to a specific process state using trigger events. This allows control over where a process should flow next. For example, when a patient is being registered, the trigger event might be to check and see if the person being registered has an existing scheduled encounter. The end state would be to display the screen that enables the user to view existing scheduled encounters for that patient.

One may define the rules for a process flow by defining more than one process transition from a given process state. Each transition would have its own set of rules or trigger events defined to take the process into its next process state. When the process transitions are evaluated depends on whether the transition is marked as immediate or not and on the priority assigned to the transition. Examples of some rules governing process transition from a given process state may be:

When the context changes as a result of a user entry action, the change is manifested the next time process or class constraints or immediate or regular transitions are processed. The change does not affect which entry actions in the current state get processed.

When the context changes as a result of an exit action: The change is manifested the next time immediate transitions, process or class constraints or transition actions are processed. The change does not affect which exit actions in the current state get processed. The change may not affect the processing of regular transitions on the state in which the exit action occurs because, by definition, the regular transition has already been selected for transitioning out of the state. The change affects the processing of regular transitions on any succeeding states.

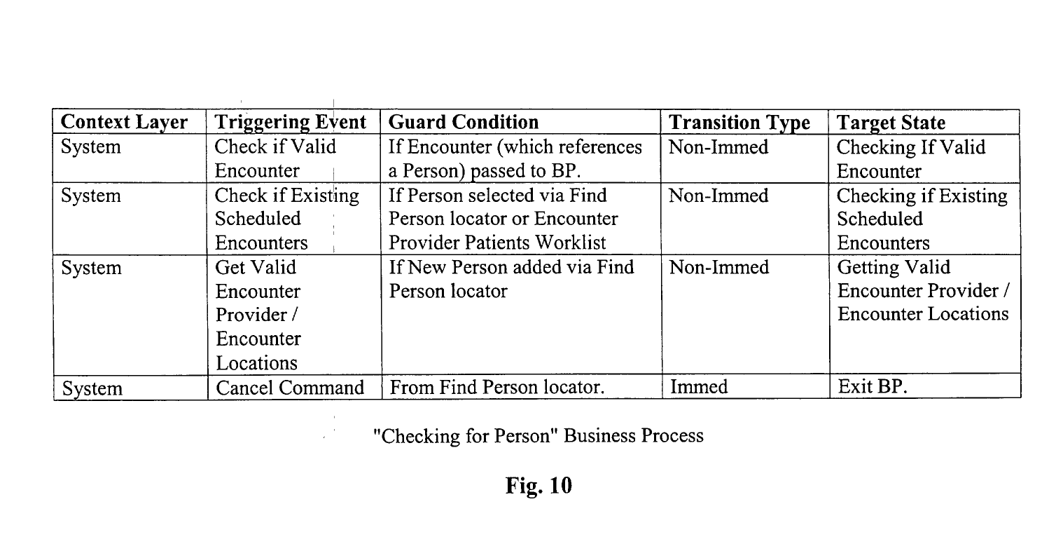

FIG. 10 illustrates more examples of process transitions for a business process Checking for Person. For example, row one of FIG. 10 shows an example of a non-immediate process transition. The triggering event for invoking this particular process transition is when an encounter is being validated as shown in column one of row one. The guard condition (e.g., constraint) for this process transition is if a patient encounter is being passed to a related business process. The transition type is indicated as being non-immediate since this transition will not be performed until the current process is valid (e.g., performed) in its current state. Additionally, row four of FIG. 10 shows an example of an immediate transition. The triggering event for this transition is a “Cancel” command issued by a user. In this case, this transition takes effect immediately upon the command entry.

Business Process Object Templates (BPOTs)

A business process object templates state machine contains a set of steps or conditions that make up a business process. These steps or conditions of a BPOT state machine are called states. For example, a business process that allows a person to be admitted to a hospital could include states called:

Collect Patient Demographics

Get Insurances

Get Guarantor

Add New Patient

When a user chooses to execute a particular business function, the state machine of the BPOT defined for the business function begins executing. An instance of an executing BPOT state machine is called a business process. The purpose of a business process is to perform the steps or resolve the conditions that correspond to states of a BPOT state machine.

When a business process begins executing, its state machine begins executing at the BPOT's start-state. Every BPOT state machine definition needs to specify exactly one start-state. The start-state specifies the state of a state machine where the business process begins processing.

Typically, after the business process begins executing, the user interacts with one or more forms (screens). How the user interacts with the forms determines how the state machine is processed. The processing of a BPOT state machine consists of moving from one state (step or condition of a business process) to another state (step or condition of a business process).

An end-state is a state where the processing of the state machine ends. Unlike start-states, any number of end-states may be specified in a BPOT definition. Each end-state corresponds to how a particular business process may end. Examples of possible end-state names are: Check-in Completion, Patient Successfully Admitted, User Cancelled Out of Function and Unexpected Error Encountered.

When a BPOT is defined, the developer defines a super set of states, that is, the set of all possible steps or conditions that may be possible for a given business function. The user interacting with the form(s) of the business process and the conditions that exist when the business process executes determine the actual states that are encountered when the business process executes. The execution of a business process consists of a flow through the state machine that begins at the BPOT's start-state and ends at one of the end-states defined in the BPOT.

The BPOT describes a business process and contains the description and rules for the business process. The adaptability context allows business processes to be created without programming. The business process definition comprises relevant data, and the business process interpreters/processors use that data.

A BPOT instance has a state transition diagram, which describes the process. This description of how a business process should flow is required when an instance of a business process is created. Each instance of a business process needs to have a BPOT instance that describes the business process it needs to handle.

A BPOT may be used as a state within another BPOT. For example, the revised encounter business process may be incorporated in a business office business process such as collections.

A business process object (BPO) is a particular process in a state with a set of participant business objects. Participant business objects might include patient, person, encounter or diagnosis. A context layer needs to be specified when the BPO is created corresponding to the organization on whose behalf the process is being performed. The BPO's context adaptability reflects the organizational or situational context associated with the user executing the BPO. The adaptability context determines which rule system elements are available and which are blocked during execution of the BPO. The context may change as the BPO executes so that the rule system elements that are available and/or blocked may change. The executing BPO may be adapted based on how the organizational or situational context changes.

Typically, a BPO instance is created when a user on a workstation (at an office within an organization) makes a UI gesture (for example, clicking on the Check in button). The BPO instance is created by a BPO factory/processor, which is provided by the adaptability framework. The BPO factory/processor accepts a business process name to determine what BPO template to use for the business process. The BPO's state machine, provided by the adaptability framework, is run and uses the information specified in the BPOT to determine the participant business objects and business process states and transitions to use during the processing of the BPO instance.

Business objects are code created by software providers. Each business object contains methods that perform some type of work. For example, patient business object has a method to return the patient's legal name and another to get a patient's age. The rules in conjunction with the business process are used to orchestrate the behaviors and methods of the business objects. For instance, a Rule System Element might ask the patient business object if the patient is old enough to be his own guarantor. The rule might be that a patient may only be his own guarantor if he is 18 years of age or older. Depending on the response from the associated business object method, the patient may or may not be allowed to be his own guarantor. The user interface continues to change based on this behind the scenes interaction between the Rule System

Element and the business object Participant.

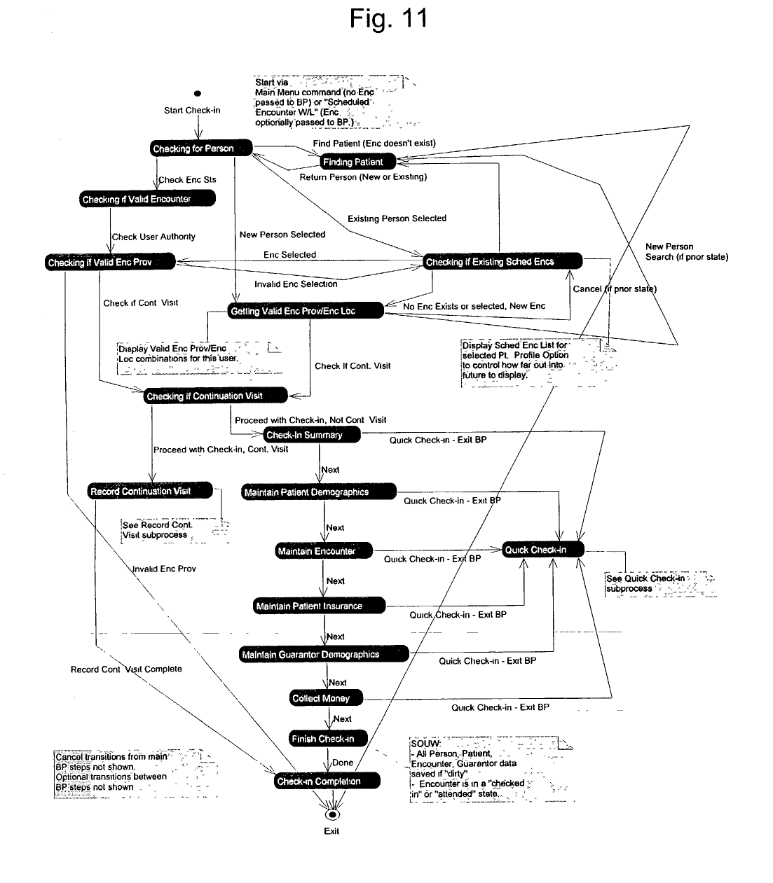

An example of a state diagram of business process object template for “Check In” validation business process is illustrated in FIG. 11.

Actions

Actions are used to invoke methods on business objects to accomplish some type of work in a process state. For example, an action might be used to trigger the printing of a document or the creation of a bill for the patient.

Suppose that as the last state in a check in process, the user wants to generate a face sheet. First, a method on one of the participating objects would need to support producing a face sheet. Let's assume the business process is called Create Face Sheet for Check In. The following exemplary steps do or do not occur depending on the constraints defined:

Return true if a face sheet has already been generated for this encounter.

Generate a face sheet and return true if a face sheet has not yet been created.

Return false if the face sheet could not be created for some reason.

Allowable Value List

Allowable value lists may show different items depending on the business process being executed. Items may either be excluded from a list or added to a list to accommodate the business scenario being executed. These Rule System Elements may be used to define lists of allowable values for a specific attribute. These lists may be adapted by context in the following exemplary ways:

Items may be excluded from a list.

Items may be added to a list and their behavior mapped to a model value.

Item descriptions and mnemonics may be overridden.

List may be created to support many languages.

Typically, allowable value lists appear on the user interface and are used to validate entered data.

Functional Operation

Further explaination of the exemplary context layer diagram shown in FIG. 6 helps demonstrate the capabilities of the present invention in more detail. As noted before,

ABC Health 610 in FIG. 6 represents an enterprise or client level of the framework and the highest level where a customer's rules and business processes may be defined, according to the principles of the present invention.

Also, in accordance with the present invention, the user interface presented for example, a check in process varies based on the use of the context adaptability framework, as further explained below.

Doctor's Office Constraint Example

Through the Rule System Elements and the blocking mechanism, the user interface for an exemplary check in process excludes certain elements that are not necessary for the doctor's office to capture. Examples include: arrival date, arrival time, encounter source, and urgency code. Although these elements are blocked for the Doctor's Office, they may be unblocked for use in the acute care facility that is part of the same health system, for example.

Hospital (Inpatient) Constraint Example

In the hospital example, no elements are blocked. The hospital may want to gather all of the information including but limited to, for example, the following information: reason for encounter, DX description, Admission type, clinical service, etc.

Hospital (Emergency) Constraint Example

Class constraints are used extensively in the ER check in process to enable desired fields to be bypassed to expedite the processing of an emergency case. If not populated, desired elements appear on a worklist for future follow up. This enables the user to process the check in quickly in order to provide patient care, without worrying about keeping track of missing data elements. Another example of a constraint for the Emergency Dept would be the use of triage classification. Triage classification would be important information to capture for emergencies, but not appropriate for either a physician's office or inpatient visit.

Doctor's Office Profile Example

An example of use of a profile in a check in process is Collect Money Profile. The profile may be valued to “yes” or “no” depending on whether the facility wants to collect money during the check in process. The doctor's office may choose to collect money for a co-payment due, therefore setting the profile to yes.

Hospital (Inpatient) Profile Example

An example of a profile used by the acute care setting is Require Primary Location Assignment Profile. If the profile is set to yes, then the primary location assignment is required to complete the check in process.

Hospital (Emergency) Profile Example

The Emergency Room may choose to set Include Display Of Existing Scheduled Encounters At Checkin Profile to “false.” Since emergency room visits are not planned by nature, the display of scheduled visits is inappropriate.

Doctor's Office Allowable Value Example

A doctor's office may choose to block certain services from an allowable value list. These services may be appropriate for other facilities, but not for the doctor's office. An example of a service excluded for the doctor's office is Consult. Although consults are common in the acute care setting, they are inappropriate for the doctor's office. The use of the context adaptability framework enables the user interface to reflect only those components necessary to support workflow.

The above examples demonstrate how contextual rules utilize the adaptability framework according to the present invention may be utilized to drive a specific user interface look and feel. The examples also demonstrate that the present invention may support operational processes without programming. Since user interfaces according to the principles of the present invention incorporate rules specified by the stakeholders of each process, the most recent updates or changes to processing rules may be presented to the user. This dynamic user interface maximizes workflow efficiency and enforce health system rules as defined by each entity. Our developers of the present software is able to create and modify our model templates for customers with little or no coding.

Furthermore, rules definition and healthcare customization are defined for each stakeholder. Rules enforcement are also defined by healthcare institution and executed dynamically. This invention also provides ability to customize each application without extensive programming experience therefore facilitates multi-entity adaptations of the software.

In addition, the present adaptation framework is specified as belonging to a context associated with any of a number of separate entities: a system, a customer, a regulatory environment, an organization, an office, etc. Therefore the adaptability—rules, processes, and workflows—is accomplished without programming. The elements of adaptability are data.

The framework thus provides a mechanism for entities to disable business logic when the owner of the logic allows such disablement. This is accomplished by, for example, blocking as described before. The framework also provides an adaptability mechanism for checking the validity of business objects. Business objects may simultaneously interact in multiple processes and in different contexts. The framework provides an adaptability mechanism for describing business processes which may take place over extended periods of time. The framework thus provides an adaptability mechanism for describing workflows.

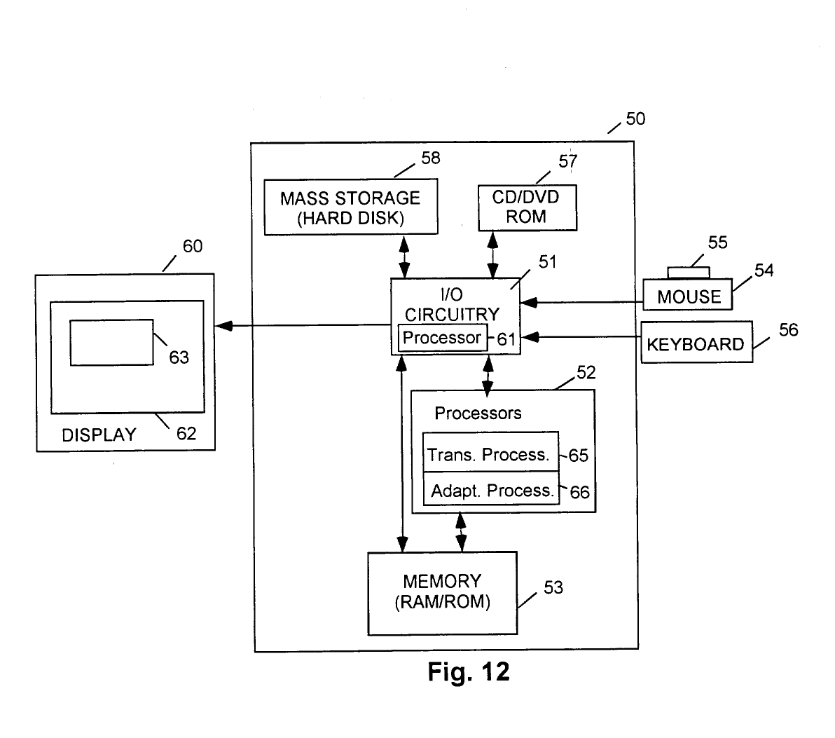

FIG. 12 describes an exemplary system for processing exemplary software and generating user interfaces in accordance with the teachings of the present invention. System 50 may comprise a general-purpose computer or a specially constructed computer. A general purpose or specially constructed computer may be used with a program or programs in accordance with the teachings herein. An example of a general-purpose computer may be an IBM-compatible personal computer, capable of running MS Windows®. An example of a specialized machine may be a medical system for used in healthcare field.

The user interfaces of the present invention, as shown for example, in FIGS. 1, 2, 8 and 9, may be implemented using an exemplary system illustrated in FIG. 12. System 50 comprises an input/output (I/O) section 51 which is used to communicate information in an appropriate form to and from other components of system 50. I/O section 51 comprises an output processor 61. In addition, system 50 comprises a processor section 52 coupled to I/O section 51 and a memory 53 such as RAM and/or ROM for storing computer programs and other information to be executed. Processor section 52 comprises at least a tracking processor 65 and an adaptation processor 66. Although shown here as two separate processors 65 and 66, one skilled in the art may readily recognize that a single processor may perform the function of both of them. The actual number of processors may vary, depending on the specific implementation of a particular hardware system.

System 50 includes a display 60, such as, for example, a CRT monitor, a liquid crystal display (LCD), or others. It further includes a user cursor control 54, such as, for example, a mouse, a track ball, joystick or other devices for selectively positioning, for example, a cursor (not shown) on a display screen 62 of the display 60. Typically, cursor control 54 includes a signal generation means, such as a switch 55 which a user of the computer system may use to generate signals directing the computer to execute certain commands which have been focused or enabled by the cursor control 54. System 50 also includes a keyboard 56 to input data and commands from a user, as is well known in the art.

Also shown in FIG. 12 is a mass storage device 58, such as a hard disk, coupled to I/O circuit 51 to provide additional storage capability for computer 50. In addition, a CD/DVD ROM 57 is further coupled to I/O circuit 50 for additional storage capacity or as another I/O device. It will be appreciated that additional devices (not shown) may be coupled to computer 50 for various purposes, as well known in the art.

As illustrated in FIG. 12, display 60 comprises a display screen or window 62 in which a sub-window 63 is displayed. An example of a display screen 62 is shown, for example, as display screen 10 of FIG. 1, display screen 20 of FIG. 2, display screen 80 of FIG. 8, or display screen 90 of FIG. 9. An example of a sub-window 63 is shown, for example, as window 92 of FIG. 9.

It is to be understood that the embodiments and variations shown and described herein are for illustrations only and that various modifications may be implemented by those skilled in the art without departing from the scope of the invention.

1. A system for dynamically generating user interface display images supporting a particular business process, comprising:
a source of information identifying a sequence of tasks involved in a business process and associated template forms for user interface display;
a tracking processor for identifying a particular task of said sequence of tasks and a template form associated with said particular task;
an adaptation processor for modifying data representing said identified form to adapt said identified form in response to user context information assisting identification of form requirements; and
an output processor for processing data representing said adapted form to be suitable for output communication.

2. A system according to claim 1, wherein
said user context information is derived from at least one of, (a) user logon identification information, (b) a user selection of an item in a displayed list of context identification items and (c) a user prior navigation path through an executable application.

3. A system according to claim 1, wherein
said user context information comprises information identifying at least one of, (a) an organization associated with said user, (b) a department of an organization associated with said user and (c) an encounter type comprising a type of interaction of a patient with a healthcare enterprise, (d) a regulatory environment, (e) customer identification information and (f) a computer system.

4. A system according to claim 1, wherein
said form adaptation processor modifies said data representing said identified form to at least one of, (a) inactivate a display element in said identified form, (b) hide a display element in said identified form and (c) add a user selectable prompt display element in said identified form.

5. A system according to claim 1, wherein
said adaptation processor also selects said form to be modified from said template forms, in response to said user context information and
said selected form is for use in performing said particular task.

6. A system according to claim 1, wherein
said tracking processor comprises a software procedure for monitoring progress in said business process and for identifying a form associated with a current task to be performed in said business process.

7. A system according to claim 1, wherein
said procedure tracks progress in said business process by allocating states of a state machine individually associated with corresponding tasks.

8. A system according to claim 1, wherein
said source of information identifies a plurality of task sequences involved in a corresponding plurality of business processes and associated template forms for user interface display and identifies said sequence of tasks involved in said business process and said associated template forms in response to at least one of, (a) said user context information, (b) predetermined business process selection information and (c) predetermined template form selection information.

9. A system according to claim 1, wherein
said source of information identifies a sequence of tasks involved in a healthcare related business process and associated template forms including at least one of, (a) a patient hospital check in form, (b) a patient check out form, (c) a form for assisting in collection of payment from a patient, (d) a billing statement form for a patient, (e) a form associated with treatment orders for a patient, (f) a form associated with test results for a patient, (g) a form associated with scheduling of tasks associated with treatment of a patient for performance by healthcare personnel and (h) a form associated with guarantor payment responsibility for a patient.

10. A system according to claim 1, wherein
said associated template forms for user interface display have common look and feel display characteristics including a common information presentation window with at least one of, (a) a common header area for ancillary information, (b) a common control bar area and (c) a common status bar area.

11. A system for dynamically generating user interface display images supporting a particular business process, comprising:
a source of information identifying a sequence of tasks involved in a business process and associated template forms for user interface display;
a monitoring processor for identifying a particular task of said sequence of tasks;
a user interface adaptation processor for selecting a form from said template forms, in response to user context information assisting identification of form requirements, said selected form being for use in performing said particular task; and
an output processor for processing data representing said selected form to be suitable for output communication.

12. A system according to claim 11, wherein
said user interface adaptation processor modifies data representing said selected form to adapt said selected form in response to said user context information.

13. A system according to claim 12, wherein
said user interface adaptation processor modifies said data representing said selected form to at least one of, (a) inactivate a display element in said selected form, (b) hide a display element in said selected form and (c) add a user selectable prompt display element in said selected form.

14. A system for dynamically generating user interface display images supporting a particular business process, comprising:
a source of information identifying a sequence of tasks involved in a business process and associated template forms for user interface display;
a task monitoring processor for,
monitoring progress through said sequence of tasks and in response to predetermined rules, at least one of, (a) determining a next task to be performed, (b) determining a task to be bypassed and (c) initiating transition from a current task to a next task, and for
identifying a template form associated with a next task; and
an output processor for processing data representing said identified template form for output communication.

15. A system according to claim 14, wherein
said predetermined rules comprise executable stored instruction for directing selection and sequencing of performance of tasks.

16. A system according to claim 14, wherein
said stored instruction directs selection and sequencing of performance of tasks in response to at least one of, (a) input data received via a displayed form, (b) predetermined settings associated with a particular user for affecting operation of said stored instruction.

17. A system according to claim 14, wherein
said output processor modifies data representing said identified template form to adapt said identified template form in response to user context information assisting identification of form requirements.

18. A system for dynamically generating user interface display images supporting a particular business process, comprising:
a source of user interface display forms;
a user interface processor for adapting at least one of, (a) a sequence of user interface display forms presented to a user, and (b) content of a user interface display form presented to a user, in response to executable stored instruction and predetermined parameters associated with a particular user for affecting operation of said stored instruction, said predetermined parameters being selected to tailor operation of said user interface to requirements of a particular user; and
an output processor for processing data representing said identified template form for output communication.

19. A system according to claim 18, wherein
steps of a business process are associated with said user interface display forms, and
said user interface processor adapts said business process in response to said stored instruction and predetermined parameters.

20. A system according to claim 19, wherein
said user interface processor adapts said business process in response to said stored instruction and predetermined parameters by at least one of, (a) determining a next step to be performed, (b) determining a step to be bypassed and (c) initiating transition from a current step to a next step.

21. A system according to claim 19, wherein
said predetermined parameters comprise stored parameters accessed by said executable stored instruction comprising executable software code and said parameters are predetermined to configure said system for use by said particular user.

22. A system according to claim 21, wherein
said predetermined parameters comprise at least one of, (a) item values allowed for a particular user in a particular form display element and (b) constraints limiting elements displayed in a particular form for a particular user.

23. A method for building a rule-based dynamic computer user interface for healthcare workers that emulates workflow, while facilitating customization by the healthcare institution, comprising the steps of:
providing at least one of: a) an area for development of code, b) an area that represents industry best practice business rules and work flows, and c) an area where customer specific adaptations reside;
defining business processes that describe all possible processes that might be used by a health care organization; and
providing capability to adapt the defined business processes by at least one of a) scenario and b) context, and in real time changing flow of user interface screens and information presented to each user.

24. The method of claim 23 further comprises the step of providing a user interface that has a consistent look and feel across all functions.
